(19) United States
(12) Patent Application Publication
(10) Pub. No.: US 2025/0061329 A1
(43) Pub. Date: Feb. 20, 2025

(54) CONTENT ATTRIBUTION SYSTEM FOR ARTIFICIAL INTELLIGENCE AND MACHINE LEARNING SYSTEMS

(71) Applicant: John E. Derrick, Maryville, TN (US)

(72) Inventor: John E. Derrick, Maryville, TN (US)

(21) Appl. No.: 18/779,032

(22) Filed: Jul. 21, 2024

Related U.S. Application Data
(60) Provisional application No. 63/569,485, filed on Mar. 25, 2024.
(60) Provisional application No. 63/515,096, filed on Jul. 22, 2023.

(51) Int. Cl. G06N 3/08

(52) U.S. Cl. CPC G06N 3/08

(57) ABSTRACT

Artificial intelligence software implements a data processing structure with at least one additional virtual data storage structure operating as a parallel network of vectors tracking influence factors by which owners of proprietary data can be tracked along with the influence that their respective data sources had in developing an AI model and provides a method of modifying the influence of select data sources from an AI model. Embodiments of the disclosure include tracking not only tagged sources of training data and input stimulus data, but also calculating differential values for weights, biases and other information for saving as node vector weights. These vectors can be used to determine, and modify as desired, the contributions that these data sources provided to any given snapshot or checkpoint of the neural network.

### CROSS REFERENCE TO RELATED APPLICATIONS

This application claims priority to and incorporates by reference U.S. Provisional Patent Application Ser. No. 63/515,096 filed on Jul. 22, 2023 and entitled Content Attribution System for Artificial Intelligence and Machine Learning System.

This application also claims priority to and incorporates by reference U.S. Provisional Patent Application Ser. No. 63/569,485 filed on Mar. 25, 2024, and entitled Content Attribution System for Artificial Intelligence and Machine Learning System.

### FIELD

This disclosure relates to the field of artificial intelligence and machine learning systems and tracking data regarding ownership and sources of proprietary and non-proprietary data used to train algorithms used therein. The methods and systems of this disclosure are configured to assess the influence of respective sets of proprietary and non-proprietary data, used during artificial intelligence training, on the state of the neural network and its output. The system is further configured to allow for adjusting a contribution (i.e., an amount of influence or change in weight) that a certain training data set has had on the overall training and configuration of a neural network, even if the training with that certain data set occurred over the course of a long time period with new training data sets added in the interim up to a current version of the neural network.

### BACKGROUND

Artificial intelligence (AI) systems and machine learning (ML) algorithms implemented on computer networks are becoming increasingly prevalent in digital operations for almost every subject matter requiring data processing for large amounts of data. Most AI and ML systems require training with reliable training data before being used with real-time inputs and stimuli in commercial implementations. The training processes typically use sets of data that are selected and organized to allow AI and ML software to learn how to adjust processing variables and parameters to make reliable decisions and produce useful output.

Many kinds of AI and ML systems have been programmed to produce results similar to those that could be produced by a human brain, but only computers can process exponentially larger data sets than any human brain ever could in the same amount of time. As shown in FIGS. 1A-1I, non-limiting examples of systems that can replicate the decision making and information processing of a human brain include many different kinds of neural networks. On a very simplistic level, many neural networks are characterized graphically with each data point for decision making shown as a circular node connected to other nodes in the neural network by edges (the lines connecting the circles). FIG. 2 illustrates a highly simplified version of an example neural network 200 with input nodes 205 directing either training data or real time data across the neural network to achieve a result at the output nodes 225. The middle set of nodes 210 are often called hidden layers and are shown in more detail in the inset 230 of FIG. 2. The inset 230 illustrates how the nodes of a neural network apply input data to other nodes according to weights “w” illustrated in the figure on the lines, or edges, of the neural network.

The connections, edges, determine how inputs and the outputs of nodes are used along with weights and variable values produce a given result. In a general sense, a node may receive inputs, including data points to be processed, and sets of weights and biases and variables that have been set by the AI software in processing other nodes on the system.

Each node is assigned a function that performs a function in a certain way and to a a certain extent based on weights, biases, and sometimes an activation function to accomplish a particular result. Outputs from one node are often used by another node to an extent determined by weighting factors to perform a portion of a mathematical calculation required. Prior training of a neural network teaches the overall AI software how to set weights and parameters when the system encounters certain kinds of data points.

Obviously, training AI software is crucial to its success in processing live data. Accordingly, programmers developing AI software need clean, reliable training data to teach the AI software how to produce high quality outputs. Unfortunately, for companies and individuals producing high quality training data, assigning a monetary or financial value to the training data and the influence of the training data on the output function has become an inexact science. In part this is due to several problems in the AI community:

There is no previously known method to properly track, measure, or attribute the value of data used to train AI/ML models or measure the influence of said data to any known owner of that data.

There are no previously known objective quantifiable methods to enumerate data sources for data or content used to generate AI/ML models.

There are no previously known methods for tracing an AI/ML model response to particular sources of data or content.

There are no previously known methods to measure, determine, estimate, or track the response of an AI/ML model to a particular data or content source in a manner to distinguish training contributions from good, bad, or unknown quality data or content.

Since there is no previously known method to quantify or estimate the impact of particular data and content used in creation of the AI/ML, there is no method to measure and hence remunerate content and data source owners.

Similarly, there is no known way to track the effect of data sources used in training, and correspondingly, there is no way known to date to remove a given source of training data that has been used to train a network.

### SUMMARY

In one non-limiting embodiment, this disclosure includes systems and methods of calculating and assigning value to certain data sets or proprietary content used to train AI and ML systems and to the AI and ML system's output. The disclosure also provides a method of tracking the impact of content or training data on an AI/ML model and provides a method to track value of the content or training data used to train and operate the AI/ML model. In general, systems and methods of this disclosure use new technology to add attributes to data sets and proprietary content used to train or interact with an AI/ML function. The methods can be used to evaluate the influence of training data and content within an AI/ML function, such as but not limited to weights within a neural network. The methods can also be used to track data and content owners and provide a quantified value based on the attributed value of the influence that data and content had on the results from the AI software.

In another embodiment, this disclosure examines how training data can be cumulatively applied to a neural network over time, and the sources, types, and identifying meta data for the training data may be gathered and stored in computer memory, such as tables and data bases.

In another embodiment, this disclosure shows how any given set of training data can be evaluated for its net contribution to results and outputs of a neural network, i.e., how a given set of training data influenced a neural network's operation over time. This evaluation can be accurately conducted for a given training data set even after additional training data sets have been added to the process of training the neural network.

In another embodiment, this disclosure shows how the net contribution to the neural network by a given training data set may be changed long after the training data set was applied to train the neural network, and even after additional training data has been added to the neural network in the interim. In other words, this disclosure shows how a current version of a neural network, with its currently assigned weights and node assignments, can be retroactively updated to remove or at least attenuate the effect that a certain historical data set had on the neural network operation.

In another embodiment, this disclosure shows how the net contribution to the neural network by a given training data set may be attenuated or amplified long after the training data set was applied to train the neural network, and even after additional training data has been added to the neural network in the interim. In other words, this disclosure shows how the influence from one or more training set within a current version of a neural network, with its currently assigned weights and node assignments can be adjusted across the effects a subset or all nodes that were affected by one or more training set.

### BRIEF DESCRIPTION OF THE DRAWINGS

The accompanying drawings, which are in and constitute a part of this specification, illustrate certain examples of the present disclosure and together with the description, serve to explain, without limitation, the principles of the disclosure. Like numbers represent the same element(s) throughout the figures.

FIG. 1A is a schematic representation of example kinds of neural networks that may be implemented according to this disclosure, including but not limited to a perceptron structure.

FIG. 1B is a schematic representation of example kinds of neural networks that may be implemented according to this disclosure including but not limited to a feed forward structure.

FIG. 1C is a schematic representation of example kinds of neural networks that may be implemented according to this disclosure including but not limited to an auto encoder structure.

FIG. 1D is a schematic representation of example kinds of neural networks that may be implemented according to this disclosure including but not limited to a deep convolutional neural network.

FIG. 1E is a schematic representation of example kinds of neural networks that may be implemented according to this disclosure but not limited to a recurrent neutral neural network.

FIG. 1F is a schematic representation of example kinds of neural networks that may be implemented according to this disclosure but not limited to a Markov chain.

FIG. 1G is a schematic representation of example kinds of neural networks that may be implemented according to this disclosure but not limited to a deep residual network.

FIG. 1H is a schematic representation of example kinds of neural networks that may be implemented according to this disclosure but not limited to a Kohonen Network.

FIG. 1I is a schematic representation of example kinds of nodes that make up the neural networks shown in FIGS. 1A-1H that may be implemented according to this disclosure.

FIG. 2 is a schematic representation of a neural network by which the systems and methods of this disclosure provide avenues to attribute ownership of data used to train AI and ML software.

FIG. 3A is a schematic representation of an original neural network and its assigned nodes and input weights as updated by historical training data sets, captured in respective snapshots, to achieve a current version of the neural network for use in real time decision making by computer systems.

FIG. 3B is a schematic representation of the neural network of FIG. 3A and shows how selected sets of historical training data affect weights and biases and other information at respective nodes in the neural network. These sets of training data can be identified by the methods and systems of this disclosure to be either removed or modified in terms of their contributions to the weights and biases of the current version of the neural network.

FIG. 3C is a schematic representation of a neural network with an explanation of updating weights and biases and other information for a particular node in an inset description. The inset description explains that new implementations of this disclosure incorporate a vector of weight and/or bias differentials for each summation process within each respective node.

FIG. 3D is a schematic representation of a neural network with an explanation of updating weights and biases and other information for a particular node by using a differential vector as set forth in this disclosure.

FIG. 3E is a schematic representation of a flow chart by which a computer implementation may utilize processes of this disclosure to receive “snapshots” (also called “checkpoints”) of a status of a neural network, as trained by different historical training data sets, and using those snapshots to track, and possibly remove or modify, a contribution that the training data set of each snapshot provided to the current version of the weights and nodes of the neural network. FIG. 3E may be considered a static analysis tracking differentials of the contributions that each historical data set provided to the current version of the neural network.

FIG. 3F is a chart showing options, in a computer system according to this disclosure, by which a graphical user interface may utilize the static analysis of FIG. 3E to illustrate the contributions that certain historical data sets provided to the current version of the neural network and provide a graphical method for selecting and removing individual data sets that lead to a particular snapshot. FIG. 3F illustrates that the latest version of the neural network can be may be re-calculated with the effect of one of the input data sets being removed.

FIG. 3G is a chart showing options, in a computer system according to this disclosure, by which a graphical user interface may provide options in removing the effects of a certain kind of tagged training input for the methods of this disclosure. FIG. 3G illustrates that all training data sets of a certain tagged type can be removed in accordance with this submission.

FIG. 4A is a flow chart illustrating a computer implemented system and method of this disclosure by which a computer can receive a snapshot of a neural network, compute a new differential (delta) vector for modeling the neural network relative to a prior version, and track contributions of respective input data sets that influence a given snapshot.

FIG. 4B is a flow chart of how the systems and methods of this disclosure provide a computerized graphical interface with options for a user to select kinds of analyses and different ways of displaying analysis results to assess a status of a neural network and/or respective snapshots of a neural network.

FIG. 5A is a schematic representation of a flow chart by which a computer implementation may utilize processes of this disclosure to receive “snapshots” of a status of a neural network, as trained by different historical training data sets, and using those snapshots to provide a dynamic analysis of the contribution from content sets used to train the neural network. The dynamic analysis analyzes the contributions of the trained neural network and calculates their influence on the output of the neural network. The dynamic analysis includes backtracking from the corresponding trial version back to the historical version as received, and identifying activated nodes that were influential in achieving the corresponding output for a given input of the neural network. Once the activated nodes have been identified from a retrospective analysis of all the nodes across the corresponding trial version of the neural network, the methods and systems of this disclosure calculate contributions of the activated nodes into the corresponding trial version of the neural network.

FIG. 5B is a chart showing options, in a computer system according to this disclosure, by which a graphical user interface may utilize the dynamic analysis of FIG. 5A to illustrate the contributions that certain historical data sets provided to the current version of the neural network.

FIG. 6 is a simplified flow chart illustrating options that a computer implemented method of this disclosure utilizes to identify historical training data sets, having contributions to the weights and nodes of a current version of a neural network, and automatically removing and/or modifying (i.e., attenuating or amplifying) the current version of the neural network to account for changes necessary to the current version of the neural network.

FIG. 7 is a schematic illustration of a graphical user interface showing historical training data sets that have been used to create a current version of a neural network according to this disclosure. The historical data sets may be grouped according to types (e.g., social, news, web, and archive) and/or by time of training (e.g., each vertical series may be considered to have been used in training simultaneously).

FIG. 8 is a diagram showing a computer implemented method of utilizing a graphical user interface to select the kinds of historical data sets to be manipulated in terms of contributions to a current version of the neural network according to this disclosure.

FIG. 9 is an example of one kind of output to a graphical user interface to show different contribution levels of various historical training data sets on the current version of the neural network according to this disclosure. FIG. 9 shows an illustrative, but non-limiting as a table representation of relative or absolute change of either/both weight and bias values. In this illustration the y-axis is the width of the layer(s) and the x-axis is the layer number. The value (numeric, color, z-axis, or size, of each element in the table can be an individual value or group of values as is used in data visualizations.

FIG. 10 is an example of one computer environment in which the methods and systems of neural network manipulation may be implemented according to this disclosure.

### DETAILED DESCRIPTION

The following description of the disclosure is provided as an enabling teaching of the disclosure in its best, currently known embodiment(s). To this end, those skilled in the relevant art will recognize and appreciate that many changes can be made to the various embodiments of the embodiments described herein, while still obtaining the beneficial results of the present disclosure. It will also be apparent that some of the desired benefits of the present disclosure can be obtained by selecting some of the features of the present disclosure without utilizing other features. Accordingly, those who work in the art will recognize that many modifications and adaptations to the present disclosure are possible and can even be desirable in certain circumstances and are a part of the present disclosure. Thus, the following description is provided as illustrative of the principles of the present disclosure and not in limitation thereof.

### Terminology

Unless defined otherwise, all technical and scientific terms used herein have the same meaning as commonly understood to one of ordinary skill in the art to which this disclosure belongs.

This disclosure refers to “snapshots” of a neural network gathered at a particular point in time. Commonly used terms used for the collection of data representing the state of the neural may include a “checkpoint” and the terms can be used interchangeably herein. Without limiting that term to any one implementation, a snapshot is generally a record, or a data file, that represents a neural network in part or in whole, and may include one or more of the nodes present within a neural network, the weights and biases by which the neural network connects those nodes, data related used to define the neural network, functions used in the neural network, and associated meta data as well.

This disclosure includes analysis techniques for neural networks, but this disclosure includes all specialized software routines that are necessary to traverse particular kinds of neural networks having unique structures. The specialized software may utilize all kinds of machine language (ML) and artificial intelligence (AI) necessary to implement the systems and methods described herein.

This disclosure also includes utilizing real time analysis of an active neural network without having to download an entire snapshot of the neural network to a different system or device. In this regard, analytical techniques include options for applying methods of this disclosure to data regarding a neural network from memory as it is iteratively trained with particular data sets.

As used in the specification and claims, the singular form “a,” “an,” and “the” include plural references unless the context clearly dictates otherwise. For example, the term “an agent” includes a plurality of agents, including mixtures thereof.

As used herein, the terms “can,” “may,” “optionally,” “can optionally,” and “may optionally” are used interchangeably and are meant to include cases in which the condition occurs as well as cases in which the condition does not occur. Thus, for example, the statement that a formulation “may include an excipient” is meant to include cases in which the formulation includes an excipient as well as cases in which the formulation does not include an excipient.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value” 10″ is disclosed, then “about 10” is also disclosed.

It is also important to note that the construction and arrangement of the elements of the system as shown in the preferred and other exemplary embodiments is illustrative only. Although only a certain number of embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the assemblies may be reversed or otherwise varied, the length or width of the structures and/or members or connectors or other elements of the system may be varied, the nature or number of adjustment or attachment positions provided between the elements may be varied. It should be noted that the elements and/or assemblies of the system may be constructed from any of a wide variety of materials that provide sufficient strength or durability. Accordingly, all such modifications are intended to be included within the scope of the present disclosure. The order or sequence of any process or method steps may be varied or re-sequenced according to alternative embodiments. Other substitutions, modifications, changes and omissions may be made in the design, operating conditions and arrangement of the preferred and other exemplary embodiments without departing from the spirit of the present subject matter.

It should be understood that while the present disclosure has been provided in detail with respect to certain illustrative and specific aspects thereof, it should not be considered limited to such, as numerous modifications are possible without departing from the broad spirit and scope of the present disclosure as defined in the appended claims. It is, therefore, intended that the appended claims cover all such equivalent variations as fall within the true spirit and scope of the embodiments claimed herein.

In non-limiting embodiments, the apparatuses, systems, and methods of this disclosure include a data processing structure implementing artificial intelligence software with at least one additional virtual data storage structure operating as a parallel network of vectors tracking influence factors by which owners of proprietary data, used as training data sets or input stimuli, can be tracked, along with the influence (i.e., the delta values in the node weight vectors) that their respective data sources had in developing a successful AI model.

In non-limiting embodiments, this disclosure includes at least the following example functions:
a) A unique identifier, such as, but not limited to, a blockchain element or meta data tag, may be provided for each training data set, input stimulus data, or content based on the item, owner, user, or source of the datum or content. This identifier may be considered a tag stored in its own section of memory that refers to a global set of data from a source or group of sources acting as one or the identifier could refer to a single work or portion of a work from a large entity providing numerous sets of data. This data may be used as training data or input stimulus data to adjust the weights and biases and other associated training of a neural network, allowing the neural network to process inputs, apply weights appropriately to functions in the network, and make logical decisions regarding an overall set of data.
b) These unique identifiers, or tags, stored in memory for sets of training data are passed along with or in parallel to the training data and content as it is used to train or interact with the AI/ML functions within a neural network. The methods and systems of this disclosure include tracking how the respectively tagged sets of data affect the current status of weights and biases and other information in a current snapshot of the neural network.
c) A virtual data storage structure that is implemented in parallel to the AI/ML function weights is created, updated, and maintained as the AI/ML function is trained and operated.
d) A method is used to generate, update, and maintain content and data specific weights for each of various factors, variables, and parameters that are updated within the AI/ML functions within a neural network. In other embodiments, a method is used to generate these content and data specific weights and biases after the AI/ML functions within a neural network are complete (periodically or whenever it is evaluated). Multiple methods are envisioned to perform the required calculations including a direct method based on a calculation of the relative change of the AI/ML function network weight and the current value of the particular weight.
c) A lighter weight method is also disclosed to generate, update, and maintain content and data specific weights, on the fly, based on an impulse response of the training to the datum or content used as training data or input stimulus data as measured on an existing AI/ML function.
f) A method may be implemented for creating, along with the result of the AI/ML functions, when the AI/ML function is evaluated. This is performed in parallel with the AI/ML function evaluation.
g) A lighter weight method is disclosed to create a vector of delta values showing how the accumulation of training episodes have led to changes for data specific weights. The Vector of delta values can be generated using a Taylor series or similar method based on an approximation of the AI/ML function.
h) A method to compute a vector of the values of the contribution of the data or content for each computation based on the valuation of the data or content item.

Example implementations of the apparatuses, systems and methods of this disclosure are set forth in the claim set that follows here. In one embodiment, a system tracks and assigns an influence factor (or a contribution factor) to data sets used to train AI software for a particular purpose. The system also tracks and attributes ownership to data sources providing training data by tracking tags corresponding to those data sources and calculating the ways that the tagged data sources affected respectively trained versions (snapshots or checkpoints) of the neural network under consideration. In this way, each owner of training data can be paid according to the influence that their proprietary data had on the development of the AI model. In some embodiments, the system takes advantage of digital watermarks that can be placed within proprietary data to prove authenticity, source, and even ownership of a data set. The application of digital watermarks to proprietary data is described in References [1-5] listed at the end of this disclosure. The know-how required to implement digital watermarking and general concepts of AI are incorporated by reference to these publications [1-5], which are to be considered part of the background of this disclosure as if set forth fully herein.

In non-limiting embodiments, before training data or input stimulus data is fed into an AI/ML model, the system may extract certain digital watermark information and save identifying information about the data set, such as its original owner who should be paid according to the value of the data set. When the AI is working as a network to achieve human like decision making, a parallel network can be populated with information about how certain data from a particular source influenced the overall AI training and use. In some embodiments, this parallel network may be stored in an array or database within at least one virtual storage structure that is accessible by the AI software. In this way, while an AI software algorithm is running, the parallel network is available to allow developers to propagate, calculate and accumulate data source attribution during training and evaluation of the AI or ML algorithms. The influence can be assessed on a node-by-node or weight-by-weight basis while the AI software is running or can be assessed according to overall output results. One goal here is to create a fair assessment of data that is acquired to help develop the AI.

Without limiting this disclosure to any single embodiment, a summary of steps of this disclosure can be considered as follows in one example:
1. Add digital watermark (e.g., blockchain identifier or hyperlink) to digital content, data & user interaction;
2. Create and maintain a real or virtual parallel set of networks for the AI/ML network. In other words, systems and methods of this disclosure maintain either real weight values that originate from a particular data set or maintain the delta values from a particular content training set.
3. Track effects of training and user interaction on the network weights, parameters, feature maps according to each data source;
4. Evaluate the attribution of effects when AI/ML formula operates;
5. Based on the original “value/license” of digital content, data & interaction, provide attribution, provide value index, and provide financial service(s) according to the attribution.
6. For systems that are continually trained during a lifetime of use, the influence factor for a given source may be updated as new data sources are used as inputs. In other words, the valuation of proprietary data in terms of its influence on the AI parameters and results can evolve over the lifetime of the AI software.

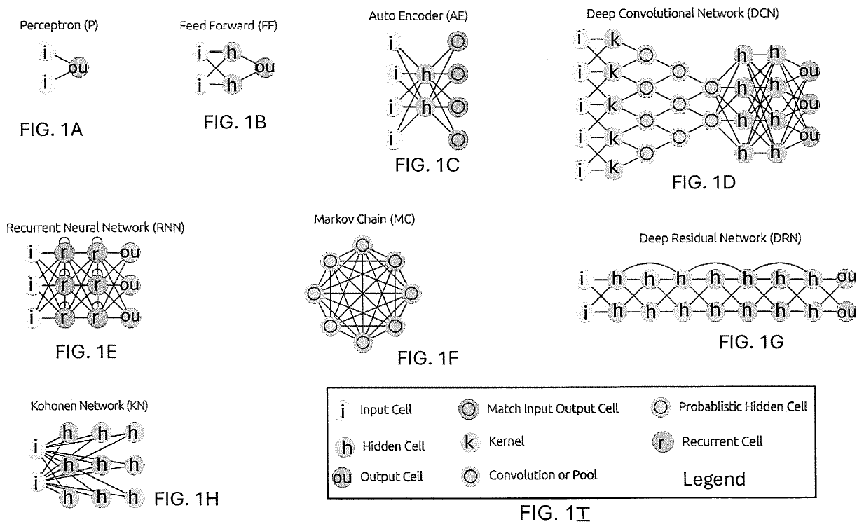

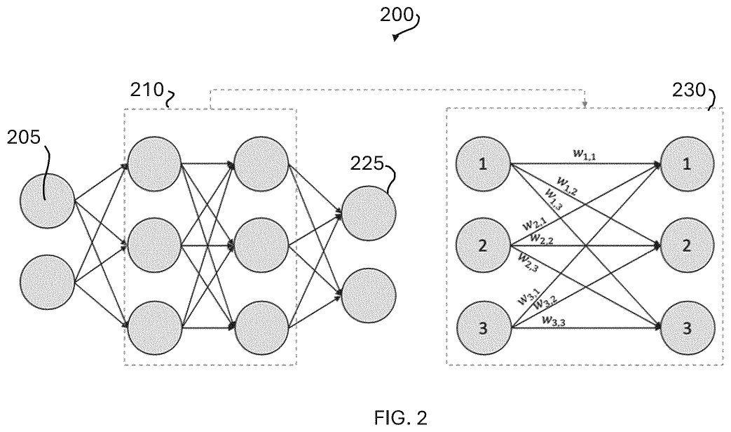

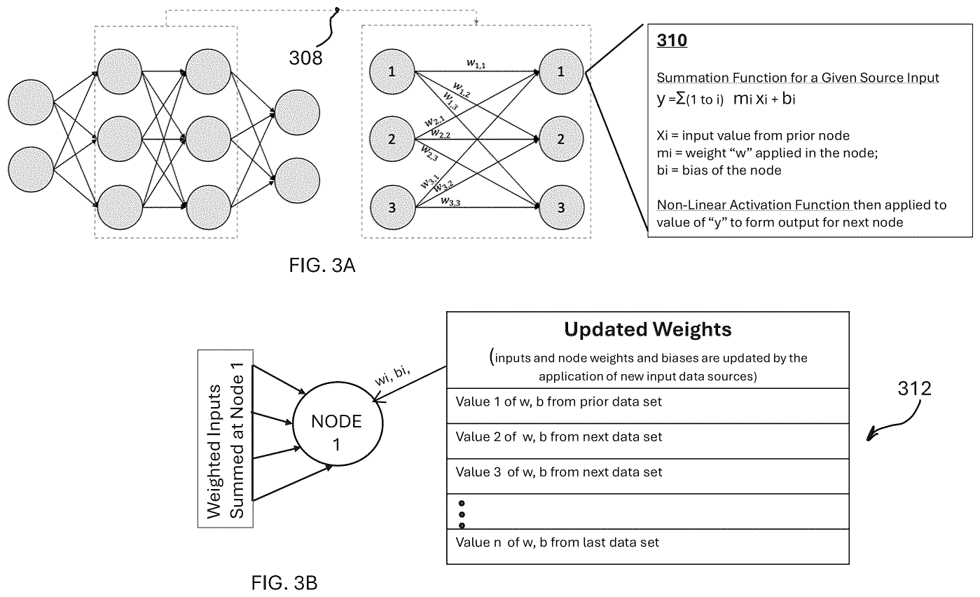

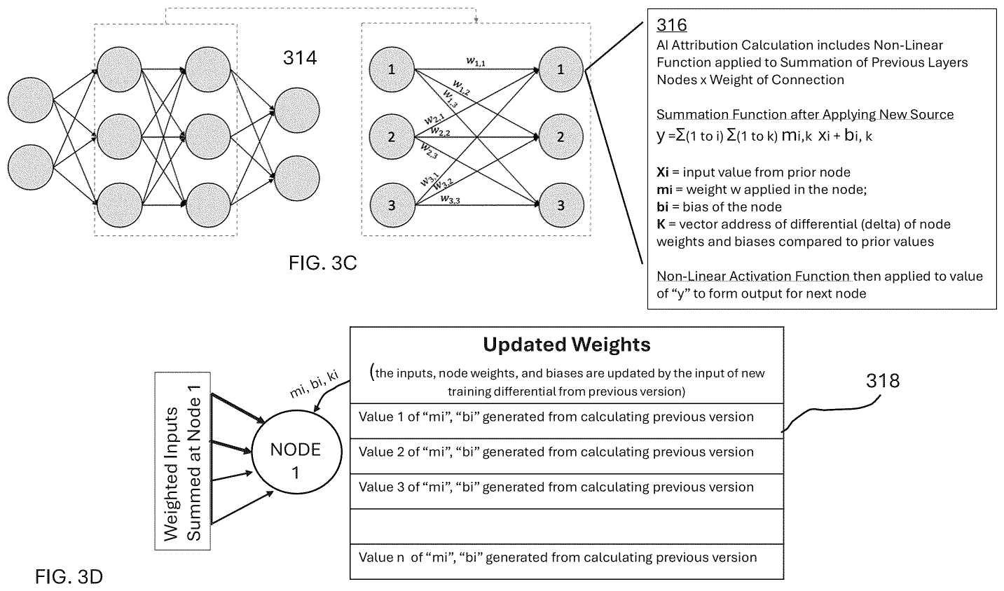

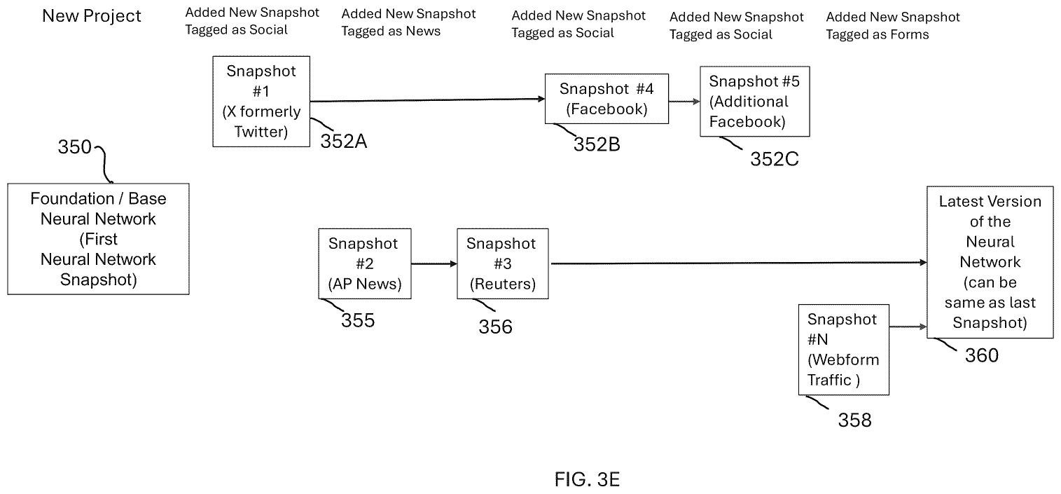

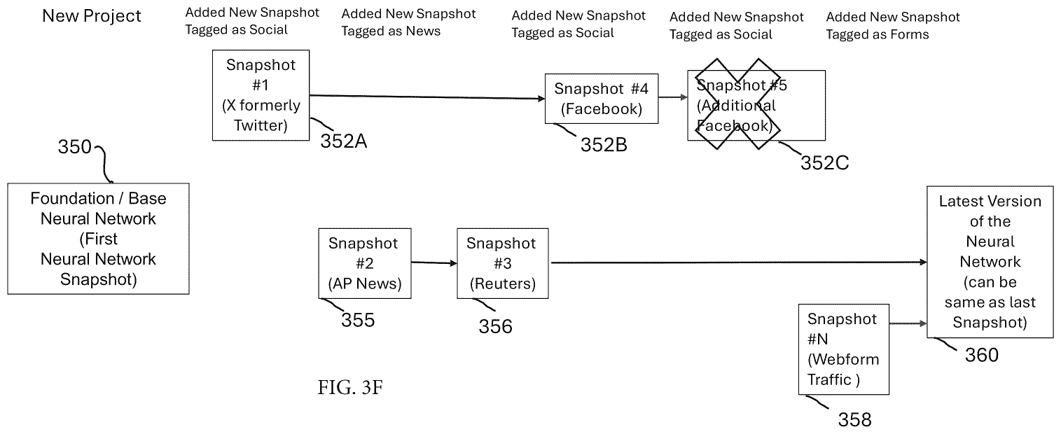

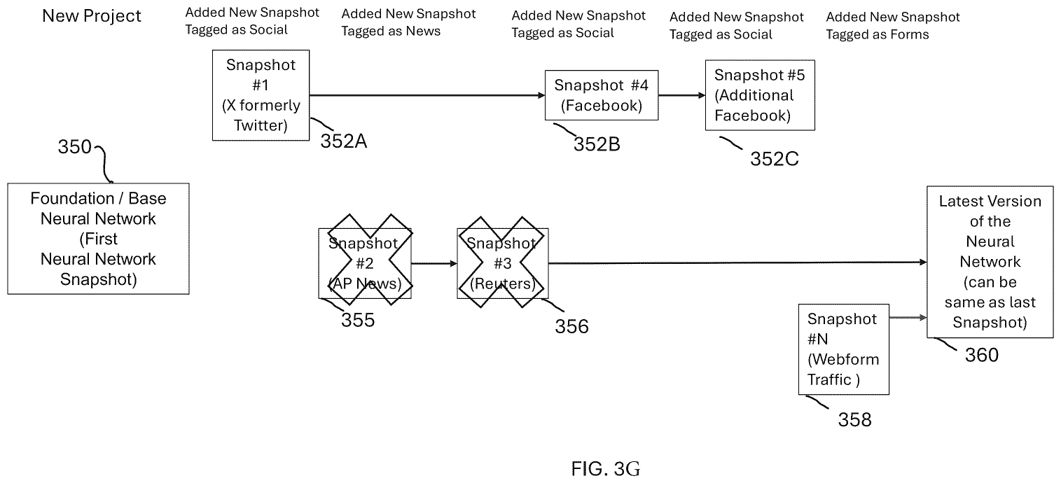

A general overview of this disclosure includes an understanding that the neural networks disclosed herein, for example those of FIGS. 1A-1I, are trained with multiple instances of historical training data sets over time, and with details of this disclosure, can be altered after the fact in terms of the influence, or contribution, that any single training data set, or even an input stimulus data set, provided to the current version of the neural network. The instances of training update the input weights, biases, and other information at the nodes of the neural network every time a training session is completed with one of the historical data sets. One non-limiting aspect of this disclosure lies in tracking the sources, types, and identifying meta data of the historical data sets as they were used in creating a current version of the neural network. Sec FIGS. 3A-3D, Refs. 308, 314. As noted herein, this disclosure makes use of a vector of delta values to track and, if necessary, modify the contribution that a certain data set has had on a respective version of the neural network. Sec FIGS. 3A-3D, Refs. 310, 316. These delta values are particularly discussed in terms of how vector weights for a node change with sequential training and input stimuli. See FIGS. 3A-3D, Refs. 312, 318. Calculation of the overall vector weight is accomplished by one of two methods. The training process results in the overall original node weight (“m” in FIG. 3C, 3D) automatically as that is the latest value due to all training in the past. This disclosure also can independently calculate the overall weight by summation of all delta weights (i.e., the weight differentials that occur from one implementation of data inputs to the next), or in the case of editing and/or modifying the weight, the summation of delta weights including the one that the system is deleting, attenuating, or amplifying. This edit function can also be performed by subtracting the delta weight (contribution) by a deleted snapshot or in the case of attenuation and/or amplification (Wn−(Ws−Ws*F)) where Wn is aggregate (current/final) of the NN, Ws is the weights for the chosen snapshot, and F is the scaling factor (less than one for attenuation, greater than one for amplification). A new set of delta weights can be created by other means to replace the selected data weight vector. One example would be removal of a set of delta weights, modify the training data used to create that set of delta weights, retrain the previous version of the model to create a new set of delta weights, and re-insert into the model. The use of these deltas are explained in regard to individual nodes by the summation equation of FIG. 3C, Ref. 316.

This disclosure then illustrates at least two approaches that can be used to alter the contributory influence that a given historical training data set has on a current version of a neural network.

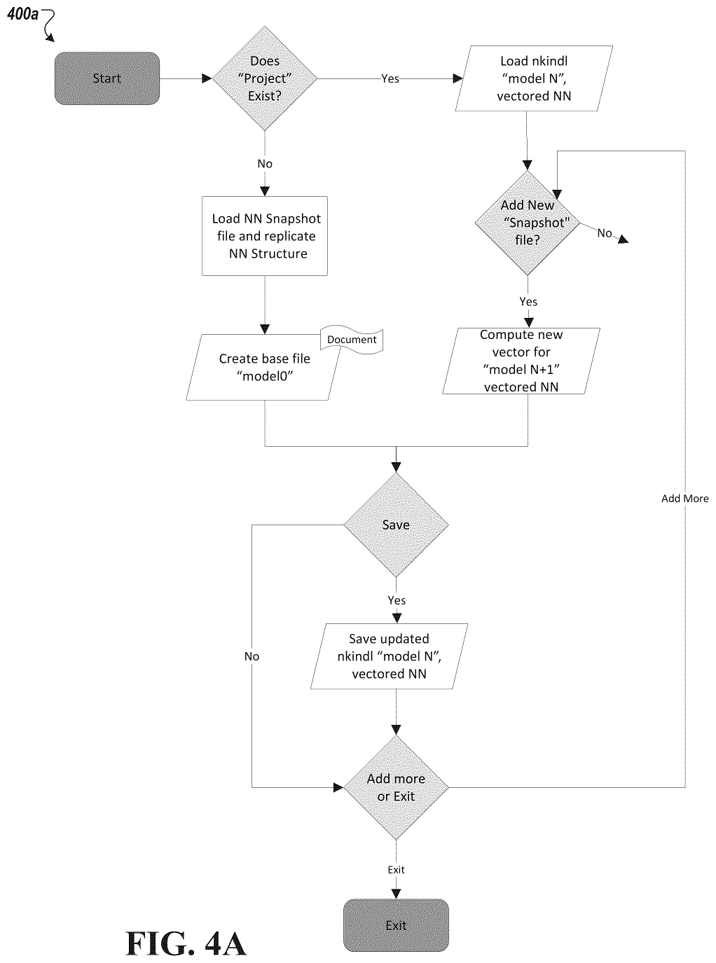

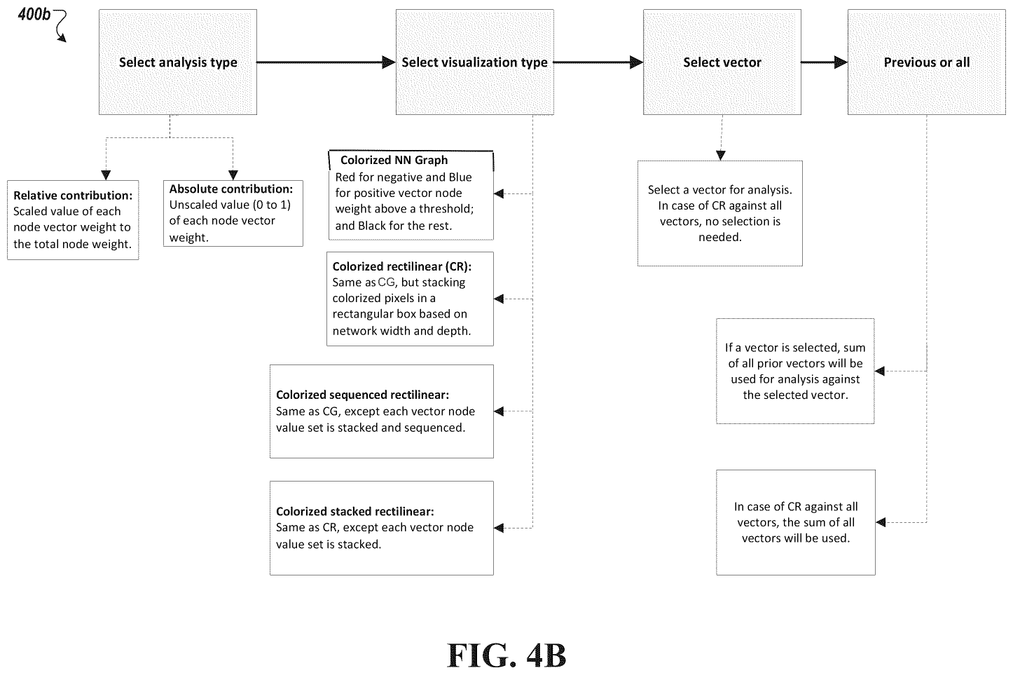

In a static analysis shown in FIGS. 4A and 4B, the contribution that a given historical training data set has on a current version of a neural network may be considered in terms of differentials of weights from one training session to a next training session or to a final current version of the neural network. In the examples of the figures, a computer system receives intermittent “snapshots” (records) of input weights in a version of the neural network that reflects the accumulation of training up to a particular instance of training with a respective historical training data set. In the static analysis, the computer implemented method of this disclosure tracks not only the identity of the historical training data sets leading to the version of the neural network under consideration, but also tracks how the identified historical training data sets changed the weights from one snapshot to the next snapshot. In non-limiting embodiments, the system tracks the differential weights that occur due to the identified training data sets changing input weights at each node. If, later down the line, after other interim training sessions have led to a current version of the neural network, the contributions of the training data sets, identifiable according to stored identification data, can be removed or modified by a subtraction process. The subtraction process may include subtracting the differential value that a given training data set provided to the cumulative weights up to a current version of the neural network.

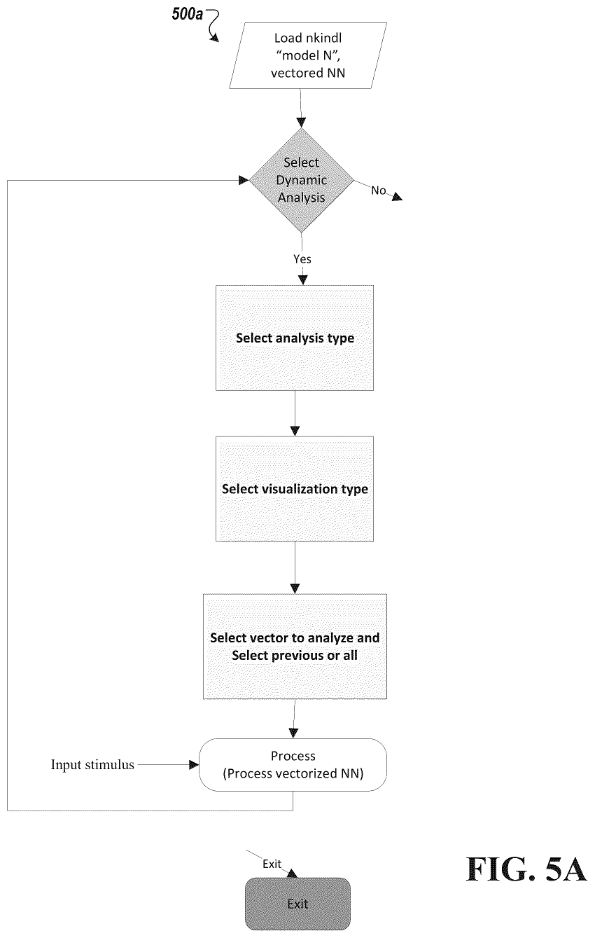

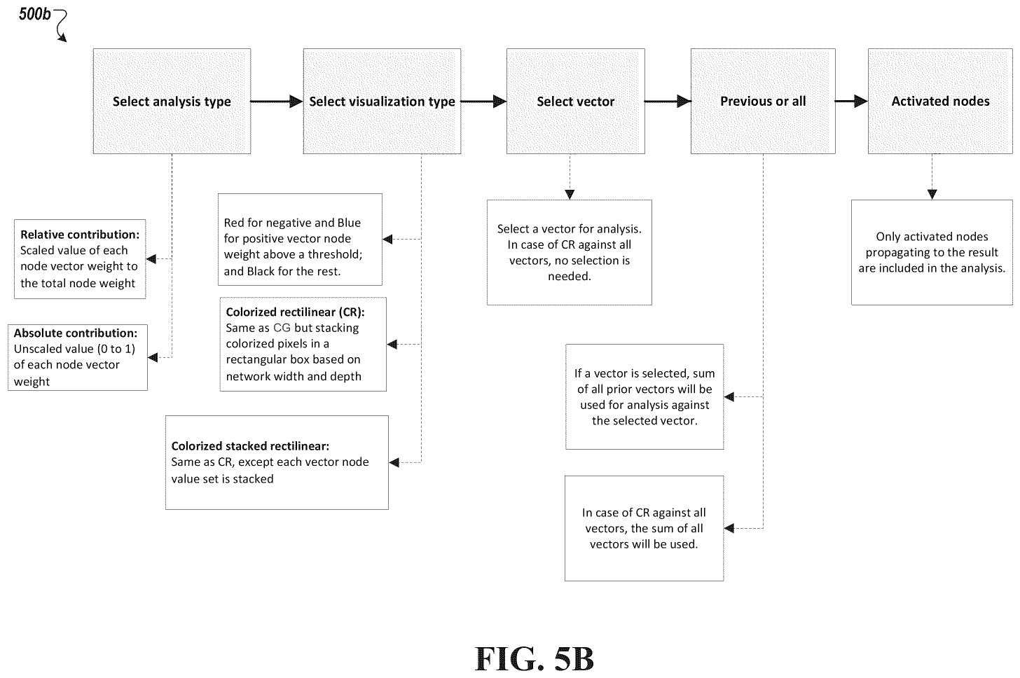

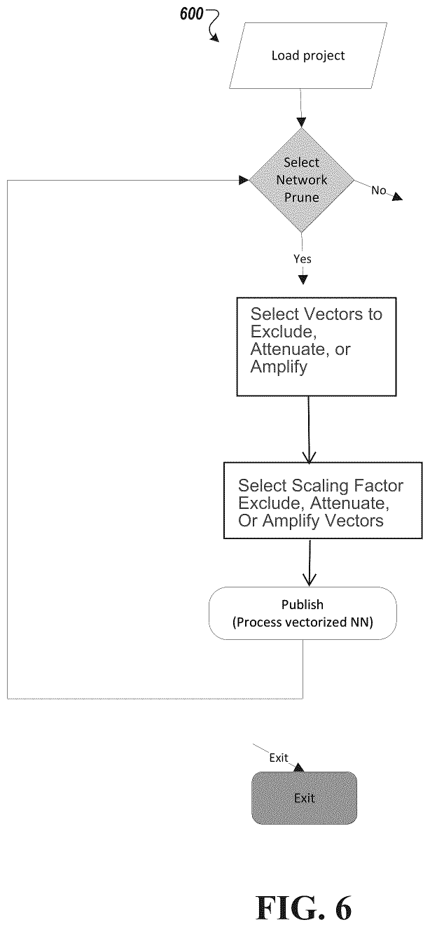

In a dynamic analysis, illustrated in part by FIGS. 5A and 5B, a two-step process occurs. First, the computer system of this disclosure receives a current version of the neural network as it has been trained over the course of many instances of historical training data sets. In a dynamic analysis, an input stimulus is applied and evaluation of the neural network is performed involving the activation of nodes within the network. A certain sample of stimulus data or particular input data may be of interest to see how that type of data affects the weights in the received version of the neural network. The computer system of this disclosure applies an input stimulus of that particular type of input stimulus or training data (e.g. social media or news or online advertising) to the received version of the neural network. The method then back tracks through the neural network to track which nodes and weights were activated by that type of stimulus data. The activated nodes can be documented for analysis while the nodes that produced no significant outputs, or did not activate, can be ignored. The system can then take the activated nodes and compare those activated nodes to earlier versions of the snapshots of the neural network over time and map out a differential contribution of the particular type of training data (i.e., the particular type of data used as a stimulus) on each activated node. This allows for a user to understand the contribution of different training data sets or different training data types to the output. Further, scaling contributed weights resulting from different training data set or different training type change the contribution of types of training data on the overall current version of the neural network. See FIG. 6, Ref. 600.

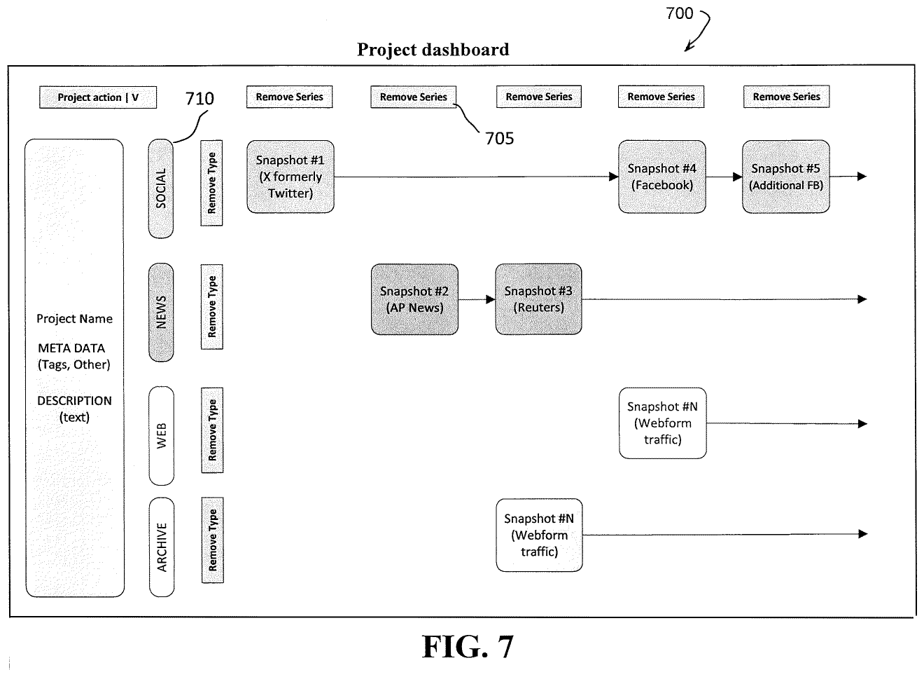

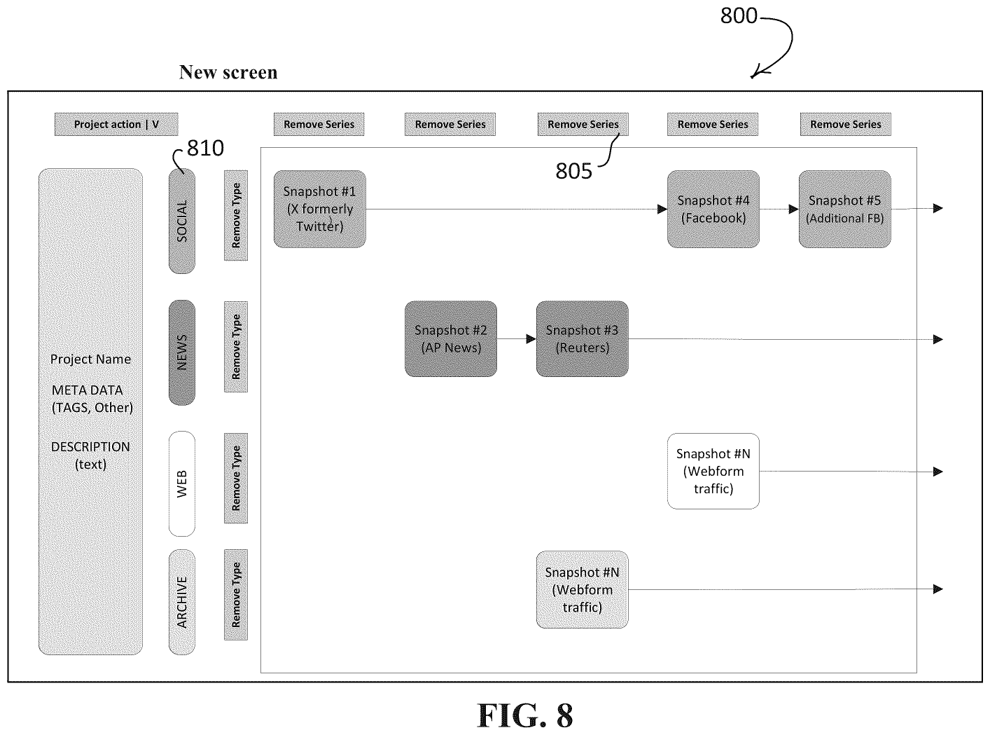

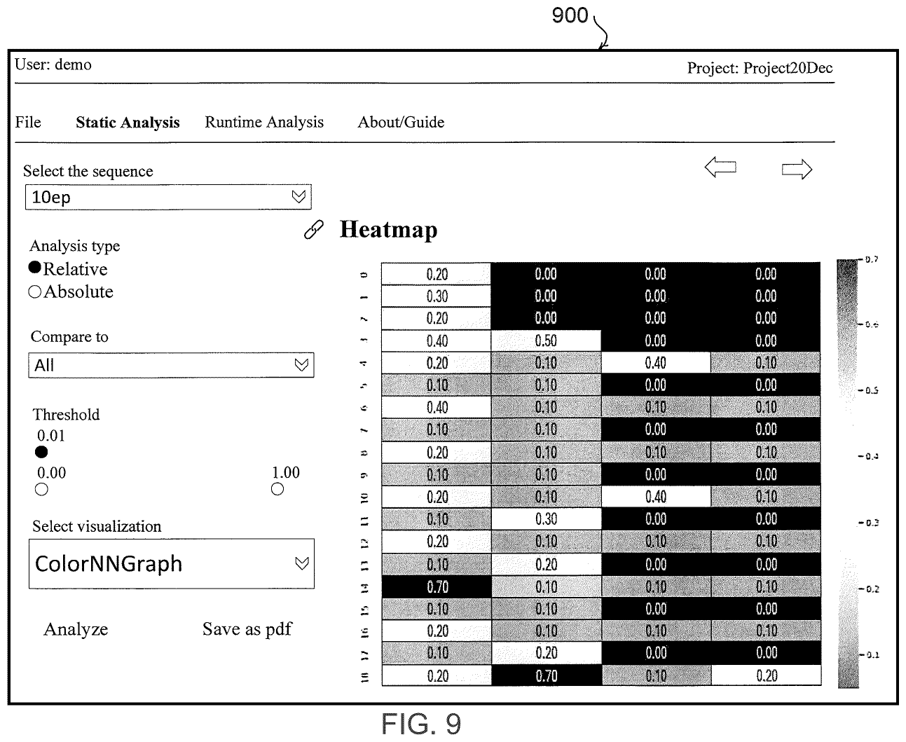

FIGS. 7-9 illustrate how a graphical user interface may be implemented with representations of a training history for a given neural network. In FIG. 7, the graphical user interface 700 arranges a grid format in which the x axis moves from left to right in the time domain, with each snapshot being received from training histories of a given neural network. The snapshots are delivered with tags (including but not limited to tables or database entries or meta data) that identify the types of training data that were included as weighted inputs to the neural network for each snapshot. Training data that included more than one type of training data at the same time would be in the same column on the grid. Training data that included a single type at different times would be in the same row on the grid. In this way, as shown in FIG. 7, the systems and methods of this disclosure allow a user to select different ways to manipulate the influence, or contribution, of more than one snapshot at the same time. As shown at the top of FIG. 7, the graphical user interface includes an option to remove training data contributions by the column, or the time domain, that includes at least one or possibly more than one type of training data contributions (that may be expressed as differential values from one time to the next). By subtracting the weight differentials that the time sequenced, input training data sets had on the consecutive iterations of the neural network weights, one can remove the contribution that certain training added to the neural network weighting system. Along the y-axis, one can also remove an entire row of contributions to the neural network by type. These kinds of global manipulations (subtracting contributions to the neural network) allow for analyses of the network that increase its accuracy. FIG. 8 is another explanatory view 800 of a similar operation shown in FIG. 7. FIG. 9 shows an example graphic 900 to display how the weight differentials across a series of two or more snapshots can be calculated to assess the contributions of different training sets on the changes to the weights of a neural network. In the example of FIG. 9, one can select only the weight differentials that meet a certain threshold difference from one snapshot to the next.

FIG. 3E illustrates embodiments of this disclosure that include computer implemented methods of tracking updates to a neural network 350 implemented by training the neural network with multiple sets of training data. A computer is connected to a data communications network to access a selected snapshot 352A, 352B, 352C, 355, 356, 358 of nodes in a neural network at a first time. The method uses the computer to access at least one of the different snapshots of the nodes in the neural network, wherein the different snapshot corresponds to a different time in some instances or simultaneous training episodes in other instances. The selected snapshot 360 and the at least one different snapshot 352A, 352B, 352C, 355, 356, 358 include changes of weights and biases and other information that have occurred on the network between the respective snapshots. The method continues by retrieving identification tags, explicit or implied, from a computer memory file, wherein the identification tags correspond to training data sets that have been used to configure both respective inputs to the neural network and the assigned weights and biases within the neural network at a particular point in time prior to the respective snapshots. The method includes maintaining a current version 360 of the neural network within computer memory by performing computer-implemented steps with a processor. The computer implemented method maintains the necessary data in memory to identify sources of training data, the contribution that each source of training data has had on a state of the neural network at a given point in time, and the weights and biases at respective nodes associated with each source of training data. The contributions may be evaluated and stored in a data file in the form of a vector of delta values corresponding to the magnitude of changes between weights and biases at respective nodes from one input data set (training data or input stimulus data) to the next.

FIG. 3F is a chart showing options, in a computer system according to this disclosure, by which a graphical user interface may utilize the static analysis of FIG. 3E to illustrate the contributions that certain historical data sets provided to the current version of the neural network and provide a graphical method for selecting and removing individual data sets that lead to a particular snapshot. FIG. 3F illustrates that the latest version of the neural network may be re-calculated with the effect of one of the input data sets being removed. This removal occurs by evaluating the contribution that a snapshot, selected for removal, has provided to the stored vectors of the differentials of weights and biases among snapshots of the neural networks. As shown in the summation notation of FIG. 3D, these differentials can be incorporated into the node value calculation by adding or subtracting the differential back in to the neural network. In this way, the contribution that a single data set, or even part of a single data set, has provided to the performance of a neural network can be removed, attenuated, or amplified at the choice of the user.

FIG. 3G is a chart showing options, in a computer system according to this disclosure, by which a graphical user interface may provide options in removing the effects of a certain kind of tagged training input for the methods of this disclosure. FIG. 3G illustrates that all training data sets of a certain tagged type can be removed in accordance with this submission. Again, instead of having to repeat an entire training history over for a given neural network, this disclosure provides the systems and methods for tracking the source and the contribution of a data set to the current snapshot of weights and biases and other information and manipulate that contribution individually without interrupting the contributions of other data sets applied to the same neural network.

In one non-limiting example shown in FIG. 4A as process 400A, the computer implemented method includes using a selected snapshot of a state of a neural network and identifying trained weights and biases changes at each node. Then the method continues by using at least one different snapshot and identifying different trained weights that nodes of the neural network exhibit due to additional inputs in the neural network.

In non-limiting examples, therefore, the method described herein generally includes iteratively incorporating respective data used for training from different data sources into a current version of the neural network, according to trained weights applied to nodes within the neural network at respective points in time. The trained weights give the neural network its ability to differentiate states of data and essentially replicate human logic in making decisions about inputs. It is useful, therefore, to determine the contribution (i.e., delta values stored in vector format) of the respective training inputs to each node of the neural network at a given point in time. Determining this contribution includes calculating, from the selected snapshot and at least one different snapshot, input weights and biases differential values for each iteration of the weights and biases exhibited at each node as of the later snapshot, which may be the most current version of the neural network under analysis. In order to track contributions of various training data sources to updated versions of the neural network, the method includes associating the identification tags of the training data sets with the differential values and storing the differential values for each iteration with the associated identification tags in the computer memory.

In other words, each data set that was ever used to train a neural network can be tracked by not only an identifier but also by the node weight differentials that the data set contributed to a current version of the neural network. All of the cumulative contributions to the neural network may, in some instances, be stored as a final iteration of the neural network and used as the current version of the neural network. Storing the current version of the neural network may include storing additional features of the neural network beyond the node weights and biases, the input data sources' identification tags, and the weight differentials. For example, a selected snapshot and any different snapshots may include meta data transmitted with respective snapshots. In some non-limiting implementations, the meta data includes the identification tags for the training data sets. In other implementations, meta data further includes content labels therein for each of the training data sets.

The methods and systems of this disclosure allow for a user to perform various kinds of absolute or relative analysis 400B of FIG. 4B upon retrieving various snapshots or even a current version of a neural network. In one embodiment, the method implements a static snapshot analysis to determine, for any one of a selected snapshot or different snapshots obtained later, a contribution by which the respective input affected updated weights and biases and other associated information at a respective node relative to a previous snapshot. In some non-limiting implementations, the contribution is expressed as a relative contribution of the respective inputs to the updated weights, biases and other information, such as, but not limited to, a numeric value calculated by dividing the individual weight changes of each respective input by the sum of respective differential values from the previous snapshot.

The static snapshot analysis described herein can determine, for any one of the selected snapshot or the different snapshots, a contribution by which the respective training input affected updated weights, biases and other information at a respective node relative to any particular snapshot of the neural network. With this data, the systems and methods of this disclosure can determine the contribution by calculating the input weight differential values of all respective inputs to the respective node, relative to any particular snapshot of the neural network. The contribution may be expressed as a percentage or relative contribution of the respective inputs to the updated weights, including a numeric value calculated by dividing the individual weight changes of each respective input by the sum of respective differential values previously calculated for the particular snapshot. Accordingly, in non-limiting examples, the contributions may be expressed as the individual weight changes relative to the particular snapshot.

A dynamic analysis 500A for a neural network is shown in FIG. 5A and may include more detailed reviews 500B of FIG. 5B of particular nodes, sets of nodes, or training data sets. In another computer implemented method of tracking updates to a neural network, the method includes using a computer connected to a data communications network to access multiple snapshots of the neural network and a current version of the neural network. The respective snapshots include weights of respective inputs implemented on edges connecting nodes in the neural network. The method uses computer implemented software to retrieve identification tags from a computer memory file, wherein the identification tags correspond to training data sets used to configure the respective inputs within the neural network prior to the respective snapshots. Analyzing outputs of the current version of the neural network includes performing computer-implemented steps with a processor, the computer implemented steps including applying a stimulus data set to the current version of the neural network to retrieve an output of the neural network; identifying active nodes used to propagate the output from the current version of the neural network; for the active nodes of the current version, calculating differential values of trained weights relative to respective snapshots from the multiple snapshots; and associating the identification tags of the training data sets with the differential values. A contribution of each training data set to the differential values is expressed as a relative contribution of the respective inputs to the updated weights, wherein the relative contribution is indicated as a numeric value calculated by dividing the individual weight changes of each respective edge used as an input to subsequent nodes by the sum of respective differential values from the respective snapshots of the neural network. The contributions are expressed as the individual weight changes of the corresponding active nodes relative to the respective snapshots of the neural network. Calculating the trained weights for any of the multiple snapshots may include summing differentials of respective weights of prior snapshots.

The computer implemented method of this disclosure, therefore, allows for editing the weights of any given version of the neural network to account for removing contributions of at least one of the training data sets to the iterations incorporating respective inputs into the neural network. The contributions of the training data sets correspond to the input weight differential values for each iteration of incorporating respective training inputs into the neural network. In one non-limiting example, editing the weights used in any version of a neural network includes subtracting respective differential weight input values that were applied to the current version of the neural network at any point in time while training the neural network. The differential weight input values may be positive values and/or negative values (i.e., subtracting a negative would essentially mean adding the contribution back in). Editing the weights, biases and information of the neural network to modify its function may also be accomplished by scaling (amplifying or attenuating) contributions of at least one of the training data sets.

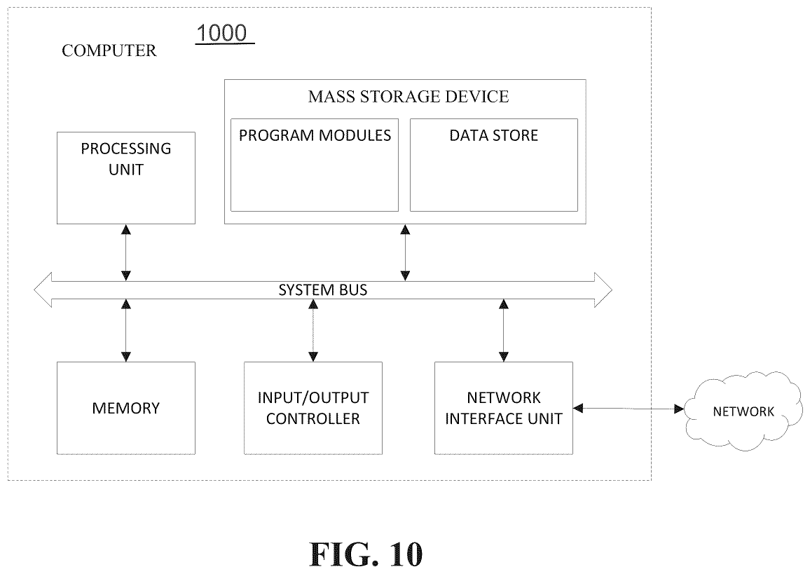

FIG. 10 shows an exemplary computing environment in which example embodiments and aspects may be implemented. The computing device 1000 environment is only one example of a suitable computing environment and is not intended to suggest any limitation as to the scope of use or functionality. FIG. 10 shows that a computer or a computerized mobile device may have a network communication interface. The processing unit has at least one processor and memory.

Numerous other general purpose or special purpose computing devices environments or configurations may be used. Examples of well-known computing devices, environments, and/or configurations that may be suitable for use include, but are not limited to, personal computers, server computers, handheld or laptop devices, multiprocessor systems, microprocessor-based systems, GPU-based systems, network personal computers (PCs), minicomputers, mainframe computers, embedded systems, distributed computing environments that include any of the above systems or devices, and the like. Special purpose computing devices, environments, and/or configurations that may be suitable for use include, but are not limited to, digital circuits, analog circuits, photonics-based circuits, and quantum computer circuits inasmuch the neural network weights and connections can be represented and processed, either by direct means or by transformation to a different state space that can represent such computation.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

Depending on the exact configuration and type of computing device, memory may be volatile (such as random-access memory (RAM)), non-volatile (such as read-only memory (ROM), flash memory, etc.), or some combination thereof.

Computing device may have additional features/functionality. For example, computing device may include additional storage (removable and/or non-removable) including, but not limited to, magnetic or optical disks or tape.

Computing devices typically include a variety of computer readable media. Computer readable media can be any available media that can be accessed by the device and includes both volatile and non-volatile media, removable and non-removable media.

Computer storage media include volatile and non-volatile, and removable and non-removable media implemented in any method or technology for storage of information such as computer readable instructions, data structures, program modules or other data. Memory, removable storage, and non-removable storage are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device.

Computing device 200 may contain communication connection(s) that allow the device to communicate with other devices. Computing device may also have input device(s) such as a keyboard, mouse, pen, voice input device, touch input device, etc. Output device(s) such as a display, speakers, printer, etc. may also be included. All these devices are well known in the art and need not be discussed at length here. For purposes herein, the computing devices of this disclosure may include a clock and a GPS or mapping system. The location of an original data source and the time of its acquisition can be used to authenticate the data and even play a role in data valuations according to this disclosure.

It should be understood that the various techniques described herein may be implemented in connection with hardware components or software components or, where appropriate, with a combination of both. Illustrative types of hardware components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. The methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

Although exemplary implementations may refer to utilizing aspects of the presently disclosed subject matter in the context of one or more stand-alone computer systems, the subject matter is not so limited, but rather may be implemented in connection with any computing environment or other distributed computing environments. Still further, aspects of the presently disclosed subject matter may be implemented in or across a plurality of processing chips or devices, and storage may similarly be implemented across a plurality of devices. Such devices might include personal computers, network servers, and handheld devices, for example.

The following references provide background information and are incorporated by reference herein.
[1] Spears, Brian K. Contemporary Machine Learning: A guide for Practitioners in the Physical Sciences; Lawrence Livermore National Laboratory, P.O. Box 808, Livermore, California 94551-0808, USA; arXiv: 1712.08523v1 [physics.comp-ph] 20 Dec. 2017.
[2] Wang et al., Data Hiding with Deep Learning: A Survey Unifying Digital Watermarking and Steganography; arXiv: 2107.09287v3 [cs.CV] 19 Apr. 2023.
[3] European Patent Application EP 1 041 805 A2; A Waternark-Data-Hiding Apparatus; Victor Company of Japan, Ltd. Oct. 4, 2000.
[4] U.S. Pat. Pub. No. 2022/0383443; Digital Watermark Analysis Apparatus and Digital Watermark Analysis Method; Canon Kabushiki Kaisha; Dec. 1, 2022.
[5] WO 2023/047114; Process for Embedding a Digital Watermark in Tokenised Data; Privitar Limited; Mar. 30, 2023.

Additional details of this disclosure supported in the claims below and the associated figures.

1. A computer implemented method of tracking updates to a neural network, the method comprising:
using a computer connected to a data communications network to access a selected snapshot of nodes in a neural network at a first time;
using the computer to access at least one different snapshot of the nodes in the neural network, wherein the different snapshot corresponds to a different time,
wherein the selected snapshot and the at least one different snapshot comprise weights of respective inputs in the neural network;
retrieving identification tags, explicit or implied, from a computer memory file, wherein the identification tags correspond to training data sets used to configure the respective inputs and the weights within the neural network prior to the respective snapshots;
maintaining a current version of the neural network by performing computer-implemented steps with a processor, the computer implemented steps further comprising:
using the selected snapshot, identifying trained weights of the respective inputs and connections in the neural network;
using the at least one different snapshot, identifying different trained weights of the respective inputs in the neural network;
iteratively incorporating the respective inputs, according to the different trained weights for each different snapshot, into the current version of the neural network;
calculating input weight differential values for each iteration of incorporating the respective inputs of different trained weights into the current version of the neural network; and
associating the identification tags of the training data sets with the differential values and storing the differential values for each iteration and the associated identification tags in the computer memory.

2. The computer implemented method of claim 1, further comprising storing a final iteration of the neural network as the current version of the neural network.

3. The computer implemented method of claim 1, wherein the selected snapshot and the different snapshot comprise meta data transmitted with respective snapshots.

4. The computer implemented method of claim 3, wherein the meta data comprises the identification tags for the training data sets.

5. The computer implemented method of claim 3 wherein the meta data further comprises content labels and other created data therein for each of the training data sets.

6. The computer implemented method of claim 1, further comprising using the computer to perform additional steps of:
implementing a static snapshot analysis to determine, for any one of the selected snapshot or the different snapshots, a contribution by which the respective input affected updated weights at a respective node relative to a previous snapshot; and
determining the contribution by calculating the input weight differential values of all respective inputs to the respective node, relative to the previous snapshot of the neural network.

7. The computer implemented method of claim 6, wherein the previous snapshot is an immediately prior snapshot relative to the different snapshot for which the static analysis was implemented.

8. The computer implemented method of claim 6, wherein the previous snapshot is any earlier snapshot in the time domain.

9. The computer implemented method of claim 6, wherein the contribution is expressed as a relative contribution of the respective inputs to the updated weights, comprising a numeric value calculated by dividing the individual weight changes of each respective input by the sum of respective differential values from the previous snapshot.

10. The computer implemented method of claim 6, wherein the contributions are expressed as the individual weight changes relative to the previous snapshot.

11. The computer implemented method of claim 1, further comprising using the computer to perform additional steps of:
implementing a static snapshot analysis to determine, for any one of the selected snapshot or the different snapshots, a contribution by which the respective input affected updated weights at a respective node relative to any particular snapshot of the neural network; and
determining the contribution by calculating the input weight differential values of all respective inputs to the respective node, relative to the particular snapshot of the neural network.

12. The computer implemented method of claim 11, wherein the contribution is expressed as a relative contribution of the respective inputs to the updated weights, comprising a numeric value calculated by dividing the individual weight changes of each respective input by the sum of respective differential values previously calculated for the particular snapshot.

13. The computer implemented method of claim 11, wherein the contributions are expressed as the individual weight changes relative to the particular snapshot.

14. The computer implemented method of claim 1, further comprising using the computer to perform additional steps of:
implementing a static snapshot analysis to determine, for any one of the selected snapshot or different snapshots, a contribution by which the respective input affected updated weights at a respective node relative to the current version of the neural network; and
determining the contribution by calculating the differential values of individual weight changes of all respective inputs to the respective node, relative to the current version of the neural network.

15. The computer implemented method of claim 14, wherein the current version of the neural network is a most recent snapshot relative to the selected snapshot or different snapshot for which the static analysis was implemented.

16. The computer implemented method of claim 14, wherein the contribution is expressed as a relative contribution of the respective inputs to the updated weights, comprising a numeric value calculated by dividing the individual weight changes of each respective input by respective differential values from the current version of the neural network.

17. The computer implemented method of claim 14, wherein the contributions are expressed as the individual weight changes relative to the current version of the neural network.

18. A computer implemented method of tracking updates to a neural network, the method comprising:
using a computer connected to a data communications network to access multiple snapshots of the neural network and a current version of the neural network;
wherein the respective snapshots comprise weights of respective inputs in the neural network;
retrieving identification tags from a computer memory file, wherein the identification tags correspond to training data sets used to configure the respective inputs within the neural network prior to the respective snapshots;
analyzing outputs of the current version of the neural network by performing computer-implemented steps with a processor, the computer implemented steps further comprising:
applying a stimulus data set to the current version of the neural network to retrieve an output of the neural network;
identifying active nodes used to propagate the output from the current version of the neural network;
for the active nodes of the current version, calculating differential values of trained weights relative to respective snapshots from the multiple snapshots;
associating the identification tags of the training data sets with the differential values.

19. The computer implemented method of claim 18, wherein a contribution of each training data set to the differential values is expressed as a relative contribution of the respective inputs to the updated weights, wherein the relative contribution comprises a numeric value calculated by dividing the individual weight changes of each respective input by the sum of respective differential values from the respective snapshots of the neural network.

20. The computer implemented method of claim 19, wherein the contributions are expressed as the individual weight changes of the corresponding active nodes relative to the respective snapshots of the neural network.

21. The computer implemented method of claim 18, further comprising calculating the trained weights for any of the multiple snapshots by summing differentials of respective weights of prior snapshots.

22. A computer implemented method of tracking updates to a neural network, the method comprising:
using a computer connected to a data communications network to access a selected snapshot of nodes in a neural network at a first time;
using the computer to access at least one different snapshot of the nodes in the neural network, wherein the different snapshot corresponds to a different time,
wherein the selected snapshot and the at least one different snapshot comprise weights of respective inputs in the neural network;
retrieving identification tags from a computer memory file, wherein the identification tags correspond to training data sets used to configure the respective inputs and the weights within the neural network prior to the respective snapshots;
maintaining a current version of the neural network by performing computer-implemented steps with a processor, the computer implemented steps further comprising:
using the selected snapshot, identifying trained weights of the respective inputs in the neural network;
using the at least one different snapshot, identifying different trained weights of the respective inputs in the neural network;
iteratively incorporating the respective inputs, according to the different trained weights for each different snapshot, into the current version of the neural network;
calculating input weight differential values for each iteration of incorporating the respective inputs of different trained weights into the current version of the neural network; and
associating the identification tags of the training data sets with the differential values and storing the differential values for each iteration and the associated identification tags in the computer memory;
editing the weights of the neural network to account for removing contributions of at least one of the training data sets to the iterations incorporating respective inputs into the neural network.

23. The computer implemented method of claim 22, wherein the contributions of the training data sets correspond to the input weight differential values for each iteration of incorporating respective inputs into the neural network.

24. The computer implemented method of claim 23, wherein editing the weights comprises subtracting respective differential weight input values to the current version of the neural network.

25. The computer implemented method of claim 24, wherein the differential weight input values comprise positive values and/or negative values.

26. A computer implemented method of tracking updates to a neural network, the method comprising:
using a computer connected to a data communications network to access a selected snapshot of nodes in a neural network at a first time;
using the computer to access at least one different snapshot of the nodes in the neural network, wherein the different snapshot corresponds to a different time,
wherein the selected snapshot and the at least one different snapshot comprise weights of respective inputs in the neural network;
retrieving identification tags from a computer memory file, wherein the identification tags correspond to training data sets used to configure the respective inputs and the weights within the neural network prior to the respective snapshots;
maintaining a current version of the neural network by performing computer-implemented steps with a processor, the computer implemented steps further comprising:
using the selected snapshot, identifying trained weights of the respective inputs in the neural network;
using the at least one different snapshot, identifying different trained weights of the respective inputs in the neural network;
iteratively incorporating the respective inputs, according to the different trained weights for each different snapshot, into the current version of the neural network;
calculating input weight differential values for each iteration of incorporating the respective inputs of different trained weights into the current version of the neural network; and
associating the identification tags of the training data sets with the differential values and storing the differential values for each iteration and the associated identification tags in the computer memory;
editing the weights of the neural network to modify its function by scaling (amplify or attenuate) contributions of at least one of the training data sets to the iterations incorporating respective inputs into the neural network.

27. The computer implemented method of claim 26, wherein the contributions of the training data sets correspond to the input weight differential values for each iteration of incorporating respective inputs into the neural network.

28. The computer implemented method of claim 27, wherein editing the weights comprises subtracting respective differential weight input values to the current version of the neural network.

29. The computer implemented method of claim 26, wherein the differential weight input values comprise positive values and/or negative values.
